(19) United States
(12) Patent Application Publication
(10) Pub. No.: US 2026/0135042 A1
(43) Pub. Date: May 14, 2026

(54) CAPACITOR

(71) Applicant: TDK Electronics AG, Muenchen (DE)

(72) Inventors: Manuel Gómez, Coin (ES); Fernando Rodriguez, Málaga (ES); Tomás Wagner, Málaga (ES); David Peláez, Torremolinos (ES); Alberto Coin Ruiz, Rincón De La Victori (ES); Justo Mercado, Málaga (ES)

(21) Appl. No.: 19/119,055

(22) PCT Filed: Oct. 12, 2023
(86) PCT No.: PCT/EP2023/078295

§ 371 Date: Apr. 7, 2025

(30) Foreign Application Priority Data
Oct. 19, 2022 (EP) 22383005.0

(51) Int. Cl. H01G 4/38; H01G 4/32

(52) U.S. Cl. CPC H01G 4/38; H01G 4/32

(57) ABSTRACT

In an embodiment a capacitor includes at least one capacitor unit having at least two winding elements, a first busbar, a second busbar, a third busbar and a fourth busbar, wherein all winding elements are arranged in a single stack, wherein the first busbar and the second busbar are arranged such that they overlap each other, wherein the first busbar and the second busbar are arranged at a first lateral face of the stack, which has a surface normal perpendicular to a stacking direction of the stack, wherein, in the stacking direction, alternatingly either the first busbar or the second busbar is connected to a top face of the winding elements, wherein the third busbar and the fourth busbar are arranged such that they overlap each other, and wherein the third busbar and the fourth busbar are arranged on a second lateral face of the stack opposite to the first lateral face.

### CROSS-REFERENCE TO RELATED APPLICATIONS

This patent application is a national phase filing under section 371 of PCT/EP2023/078295, filed Oct. 12, 2023, which claims the priority of German patent application no. 22383005.0, filed Oct. 19, 2022, each of which is incorporated herein by reference in its entirety.

### TECHNICAL FIELD

The present invention concerns a capacitor. In particular, the capacitor may be a metallized DC-link film capacitor.

### BACKGROUND

Metallized film DC-Link capacitors are critical components for many power electronics applications: renewable energies, electric vehicles, traction, motor drives, uninterruptible power supply, energy transmission, etc.

DC-Link capacitor requirements strongly depend on the parameters of a semiconductor implemented in a converter connected to the capacitor and a modulation strategy of the converter.

The development of Wide-bandgap semiconductors (WBGS), to higher on-state voltage, has changed the characteristics of high power converters: higher switching frequencies, higher harmonic frequencies, lighter cooling systems, higher power density, more compact designs, etc.

As a consequence, in order to work correctly in such applications, the capacitor should be able to be operated at high frequencies, e.g., frequencies above 10 kHz, without too many losses due to parasitic inductances and resistances.

### SUMMARY

Embodiments provide a capacitor that comprises at least one capacitor unit. The capacitor unit comprises at least two winding elements, a first busbar, a second busbar, a third busbar and a fourth busbar, wherein all winding elements of the capacitor unit are arranged in a single stack, wherein the first busbar and the second busbar are arranged such that they overlap each other, wherein the first busbar and the second busbar are arranged at a lateral face of the stack which has a surface normal perpendicular to a stacking direction of the stack, wherein, in a stacking direction, alternatingly either the first busbar or the second busbar is connected to a top face of the winding elements, wherein the third busbar and the fourth busbar are arranged such that they overlap each other, wherein the third and the fourth busbar are arranged on a lateral face of the stack opposite to the lateral face at which the first busbar and the second busbar are arranged, wherein, in a stacking direction, alternatingly either the third busbar or the fourth busbar is connected to a bottom face of the winding elements, such that the third busbar is connected to the bottom faces of the winding elements which have a top face that is connected to the second busbar and that the fourth busbar is connected to the bottom faces of the winding elements which have a top face that is connected to the first busbar. For example, the capacitor unit may comprise four winding elements.

Embodiments provide an improved capacitor, for example, a capacitor has low and internally homogeneous losses at high switching frequencies.

A winding element may be a capacitance unit. Each winding element of the capacitor may have the same capacitance. Each winding element may have a first pole of a first polarity, e.g., a positive polarity, and a second pole of a second polarity, e.g., a negative polarity. By applying a voltage between the first and the second pole, energy may be stored in the winding element.

A busbar may be a metallic strip or a metallic bar configured for local high current power distribution.

A small inductance between the winding elements is important for a power capacitor as a high inductance would result in resonance effects and high losses due to parasitic inductances and resistances.

Overall, homogeneous impedance can be provided by each winding element having the same capacitance and by each connection from a terminal to a winding element having the same inductance. Due to design requirements, it may not always be possible to provide the same inductance for each winding element. Thus, instead of trying to adapt the inductances to each other, it is proposed to reduce the inductances to minimal values by cancelling or weakening the magnetic fields.

A capacitor with a first and a second busbar overlapping each other may have a low equivalent series resistance (ESR), a frequency-stable ESR, a low equivalent series inductance (ESL), and a homogeneous internal current distribution. Internal resonances may be avoided.

The first busbar and the second busbar may be arranged such that at least 20% of the area of the first busbar is overlapped by the second busbar. In the area of the overlap of the busbars, a thin isolator may be arranged between the busbars which prevents a short circuit between the busbars. The thin isolator may not significantly influence the magnetic fields.

The at least two winding elements may be arranged in a stack, wherein the first busbar and the second busbar are arranged at a lateral face of the stack. The lateral face of the stack may be a face that is perpendicular to a top face and a bottom face of the stack, wherein metallizations and connection elements for contacting the winding element are arranged on the top face and the bottom face of the winding elements. The top face of the stack may be formed by the top faces of the winding elements. The bottom face of the stack may be formed by the bottom faces of the winding elements.

The at least two winding elements may be arranged in a stack, wherein the first busbar and the second busbar are arranged on at least two faces of the stack. In particular, the first and the second busbar may completely or partly cover one or more lateral faces, and/or the top face and/or the bottom face of the stack.

All winding elements may be arranged in a single stack. The stack may comprise more than two winding elements.

In the stack, the top faces of each winding element may face in the same direction. The bottom face of each winding element may be opposite to the top face of the winding element. The top faces of the winding elements may form the top face of the stack. The bottom faces of the winding elements may form the bottom face of the stack that is opposite to the top face of the stack.

In this embodiment, the windings are connected to both busbars in an alternate way. Thereby, the polarities of the winding elements alternate along the stacking direction. In other words, in the stacking direction, each winding element has an opposite polarity compared to the adjacent winding element.

As a result, the magnetic flux may be compensated in all connections, including the connection between winding elements. This may result in only very small parasitic inductances and resistances between winding elements and between winding elements and terminals. By reducing the parasitic inductances and resistances, the impedance from the terminals to each winding is more homogeneous between the winding elements for each frequency in the bandwidth in which the capacitor may be operated. Thus, the performance of the capacitor in the complete bandwidth is better due to a low and frequency stable ESR, a low ESL from each pair of terminals, a homogeneous internal current distribution and the avoidance of internal resonances.

The first busbar may be folded in the section between the stacks and/or the second busbar may be folded in the section between the stacks. The fold may be formed by a 180° turn of the respective busbar.

The winding elements have a non-circular diameter. In particular, the winding element may be flat. Flat winding elements may be arranged in a stack such that no space is wasted between the winding elements.

The capacitor may be a DC link capacitor. The capacitor can be any kind of capacitor. For example, the capacitor may be a film capacitor. The capacitor may be a power capacitor.

The film capacitor may comprise metallized films.

In an embodiment, the first busbar and the second busbar are arranged such that at least 20% of the area of the first busbar is overlapped by the second busbar, and the third busbar and the fourth busbar are arranged such that at least 20% of the area of the third busbar is overlapped by the fourth busbar.

In an embodiment, the first busbar and the second busbar are arranged such that a current flowing through the first busbar generates a first magnetic field and a current flowing through the second busbar generates a second magnetic field, wherein the first magnetic field and the second magnetic field compensate each other. In the embodiment, the third busbar and the fourth busbar are arranged such that a current flowing through the third busbar generates a third magnetic field and a current flowing through the fourth busbar generates a fourth magnetic field, wherein the third magnetic field and the fourth magnetic field compensate each other.

In an embodiment, each winding element has a “A” pole and a “B” pole, wherein the “A” poles of each winding element are connected either to the first busbar or to the third busbar, and wherein the “B” poles of each winding element are connected either to the second busbar or to the fourth busbar.

In an embodiment, each of the busbars is connected to the winding elements directly, e.g. by welding or soldering.

In an embodiment, each busbar of the capacitor unit is connected to the top face or to the bottom face of the respective winding element.

In an embodiment, each busbar comprises a terminal which is configured to be connected to an external connection, resulting in a unique capacitance element which is enabled to work at a high performance and to avoid the use of an internal connection. In particular, it is not necessary to provide an internal busbar which is used in addition to the four busbars of the capacitor unit and the terminal. By avoiding an internal connection, in particular an internal busbar, the capacitor can have a simple and cost-effective design and the number of internal elements can be kept to a minimum. Avoiding the use of an internal connection, e.g. an internal busbar, may prevent possible undesired interactions between the internal connection and the external connection.

Each of the busbars may comprise a substantially flat metal plate with tabs being arranged at a lower end and the terminal being arranged at the upper end.

In an embodiment, in the stacking direction of the stack, each winding element has an opposite polarity compared to the adjacent winding element.

In an embodiment, the winding elements are arranged in the stack such that the top faces of the winding elements are arranged at the first lateral face of the stack and the bottom faces of the winding elements are arranged at the second lateral face of the stack.

In an embodiment, the winding elements have a non-circular diameter.

In an embodiment, capacitor may be a DC link capacitor.

According to another aspect, the capacitor comprises two or more capacitor units, wherein each capacitor unit comprises at least two winding elements, e.g. four winding elements, a first busbar, a second busbar, a third busbar and a fourth busbar, wherein all winding elements of each capacitor unit are arranged in a single stack, wherein the first busbar and the second busbar are arranged such that they overlap each other, wherein the first busbar and the second busbar are arranged at a lateral face of the stack which has a surface normal perpendicular to a stacking direction of the stack, wherein, in a stacking direction, alternatingly either the first busbar or the second busbar is connected to a top face of the winding elements, wherein the third busbar and the fourth busbar are arranged such that they overlap each other, wherein the third and the fourth busbar are arranged on a lateral face of the stack opposite to the lateral face at which the first busbar and the second busbar are arranged, wherein, in a stacking direction, alternatingly either the third busbar or the fourth busbar is connected to a bottom face of the winding elements, such that the third busbar is connected to the bottom faces of the winding elements which have a top face that is connected to the second busbar and that the fourth busbar is connected to the bottom faces of the winding elements which have a top face that is connected to the first busbar.

In an embodiment, the two or more capacitor units are arranged such that the stacks of winding elements of each of the two or more capacitor units are arranged in a row wherein the stacking directions of the stacks are parallel to each other. Alternatively, the capacitor units may be arranged in multiple rows. For example, the capacitor may comprise four capacitor units, wherein two units are arranged in a first row and two units are arranged in a second row parallel to the first row. As another example, the capacitor may comprise six capacitor units, wherein three units are arranged in a first row and two units are arranged in a second row parallel to the first row. Moreover, other numbers of rows and capacitor units are also possible.

In an embodiment, the capacitor comprises an encapsulation which encloses the capacitor units.

In an embodiment, in each capacitor unit, each busbar of the capacitor unit is connected to the top face or to the bottom face of the respective winding element.

In an embodiment, each busbar comprises a terminal which is configured to be connected to an external connection, resulting in a unique capacitance element which is enabled to work at a high performance and to avoid the use of an internal connection. In particular, it is not necessary to provide an internal busbar which is used in addition to the four busbars of each of the capacitor units and the terminal. By avoiding an internal connection, in particular an internal busbar, the capacitor can have a simple and cost-effective design and the number of internal elements can be kept to a minimum. Avoiding the use of an internal connection, e.g. an internal busbar, may prevent possible undesired interactions between the internal connection and the external connection.

Each of the busbars may comprise a substantially flat metal plate with tabs being arranged at a lower end and the terminal being arranged at the upper end.

In an embodiment, the capacitor may be a DC link capacitor.

### BRIEF DESCRIPTION OF THE DRAWINGS

In the following, the present invention is described with respect to the drawings:

FIG. 1 shows a comparison of the ESR of a capacitor of the seventh embodiment and a reference capacitor;

FIG. 2 shows a reference capacitor; and

FIGS. 3 to 32 show capacitor according to different embodiments.

### DETAILED DESCRIPTION OF ILLUSTRATIVE EMBODIMENTS

Embodiments of the present invention relate to a capacitor which is a DC link capacitor and which is designed, for example, for voltages above 600 V and switching frequencies of more than 10 kHz.

The capacitor comprises a plurality of winding elements 1. The capacitor may comprise any number of winding elements 1.

Each winding element 1 is wound around an axis. The axis extends from a bottom face 2 of the winding element 1 to a top face 3 of the winding element 1. The top face 3 of each winding element 1 is covered with a metallization 4, the so-called Schoop-layer. The metallization 4 of the top face 3 is connected to a first electrode or a first set of electrodes of the winding element. The bottom face 2 of each winding element 1 is also covered with a metallization 4, i.e., a Schoop-layer. The metallization 4 of the bottom face 3 is connected to a second electrode or a second set of electrodes of the winding element 1. The first electrode and the metallization 4 on the top face 3 or the first set of electrodes and the metallization 4 on the top face 3 form a first pole of the winding element 1. The second electrode and the metallization 4 on the bottom face 2 or the second set of electrodes and the metallization 4 on the bottom face 2 form a second pole of the winding element 1. During the operation of the capacitor 1, a voltage is applied between the first pole and the second pole.

For the sake of visualization, the first pole is marked with a “plus” in the drawings and the second pole is marked with a “minus”. As alternating currents are applied, the polarizations can be altered continuously.

On the top face 3 and on the bottom face 2 of each winding element 1 a connection element, e.g., a connection stripe or a bonding wire, can be arranged.

The winding elements 1 have a non-circular cross section. In particular, the winding elements 1 are flat.

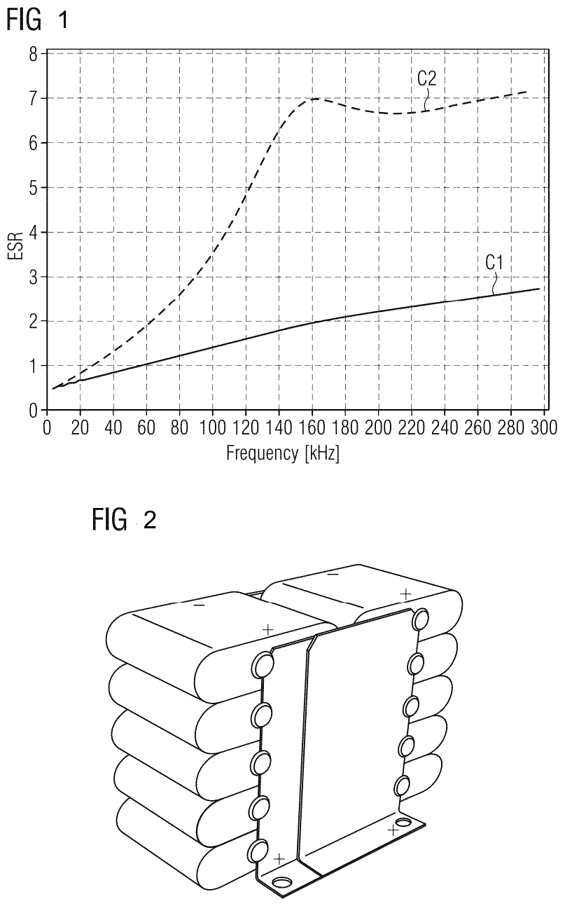

FIG. 1 shows a plot of the ESR over the frequency of a capacitor according to an embodiment of the present invention represented by curve C1 compared to a reference capacitor as shown in FIG. 2 wherein busbars of opposite polarities do not overlap each other represented by curve C2. It can be seen in FIG. 1 that the ESR of the reference capacitor is higher than the ESR of the capacitor according to the embodiment and that it is less frequency-stable due to a non-homogeneous internal current distribution and internal resonances. In particular, at frequencies higher than 10 KHz, a significant reduction in the ESR can be observed in the capacitor according to the seventh embodiment.

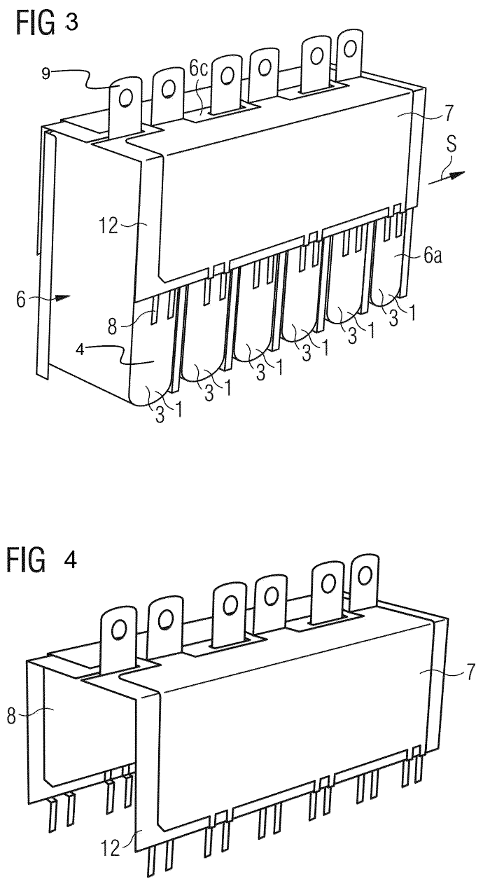

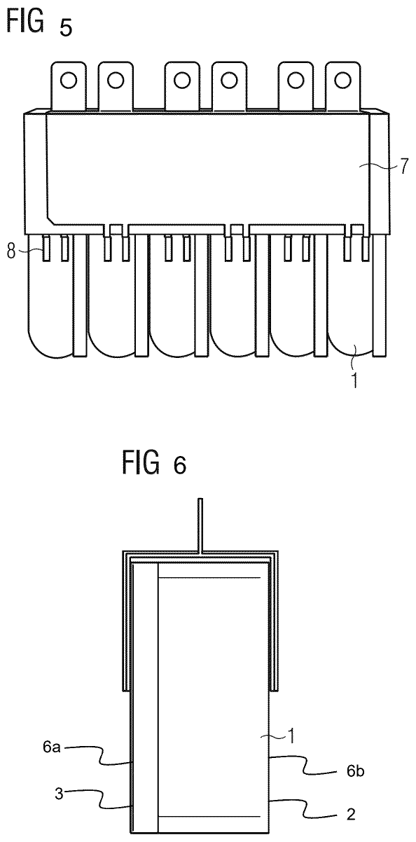

FIGS. 3 to 6 show a capacitor according to a first embodiment. FIGS. 3, 4 and 5 show perspective views of the capacitor according to a first embodiment. FIG. 3 shows a first busbar 7 and a second busbar 8 of the capacitor. Moreover, FIG. 4 shows an isolator plate 12 being arranged between the busbars 7, 8.

The capacitor comprises a first busbar 7 and a second busbar 8, which enable contacting a stack 6 of winding elements 1. In particular, the first busbar 7 is configured to apply a voltage to the first electrode or the first set of electrodes of each winding element 1. The second busbar 8 is configured to apply a voltage to the second electrode or the second set of electrodes of each winding elements 1. The first busbar 7 comprises at least one terminal 9. The first busbar 7 is configured to be connected to a pole of an external power supply, for example an insulated-gate bipolar transistor (IGBT), via the at least one terminal 9. The second busbar 8 also comprises at least one terminal 9. The second busbar 8 is configured to be connected to another pole of the external power supply, for example the insulated-gate bipolar transistor (IGBT), via the at least one terminal 9. Each of the first busbar 7 and the second busbar 8 can comprise more than one terminal 9.

The current flowing through the first busbar 7 generates a first magnetic field. The current flowing through the second busbar 8 generates a second magnetic field. As the first busbar 7 and the second busbar 8 overlap each other and as the currents in the first busbar 7 and the second busbar 8 have opposite directions, the magnetic fields generated in the first busbar 7 and in the second busbar 8 cancel each other or at least weaken each other. Thus, the arrangement of the busbars 7, 8 overlapping each other results in reduced magnetic fields of the busbars 7, 8. Thereby, the inductance of the busbars 7, 8 is reduced. As the inductance from the busbar 7, 8 to each of the winding element 1 is very low and homogeneous and as each winding element 1 has the same capacitance, each winding element 1 has almost the same impedance. If the winding elements 1 had different impedances, resonance effects in the capacitor, in particular when applying high switching frequencies above 10 kHz, would be unavoidable. Due to the overlapping busbars 7, 8, the impedance for each winding element 1 is almost the same such that no significant resonance effects occur. Accordingly, the losses in the capacitor can be reduced. In particular, parasitic inductances and resistances are strongly reduced. The impedance from the terminal 9 to each winding element 1 is homogeneous in all the frequency bandwidths. This results in a low equivalent series resistance (ESR), a frequency stable ESR, a low equivalent series inductance (ESL) and the avoidance of an internal resonance. This enables the operation of the capacitor at voltages above 600 V and at switching frequencies of more than 10 kHz.

The first busbar 7 is arranged on a first lateral face 6a of the stack and on a second lateral face 6b of the stack 6 which is opposite of the first lateral face 6a. The second busbar 8 is also arranged on the first lateral face 6a of the stack and on the second lateral face 6b of the stack 6. The first busbar 7 and the second busbar 8 overlap each other on both lateral faces 6a, 6b. On the first lateral face 6a, the top faces 3 of the winding elements 1 are alternatingly in the stacking direction connected either to the first busbar 7 or to the second busbar 8. On the second lateral face 6b, the bottom faces 3 of the winding elements 1 are alternatingly in the stacking direction connected either to the first busbar 7 or to the second busbar 8 in such a manner that a winding element 1 having its top face 3 connected to the first busbar 7 is connected to the second busbar 8 via its bottom face 2 and, vice versa, a winding element 1 having its top face 3 connected to the second busbar 8 is connected to the first busbar 7 via its bottom face 2. This connection of the two busbars 7, 8 to the winding elements 1 in an alternating manner results in the winding elements 1 having alternating polarities along the stacking direction S. Thereby, the magnetic flux of adjacent winding elements 1 can compensate each other. The compensation of the magnetic flux results in a low parasitic inductance, a low parasitic resistance and low negative electromagnetic interactions.

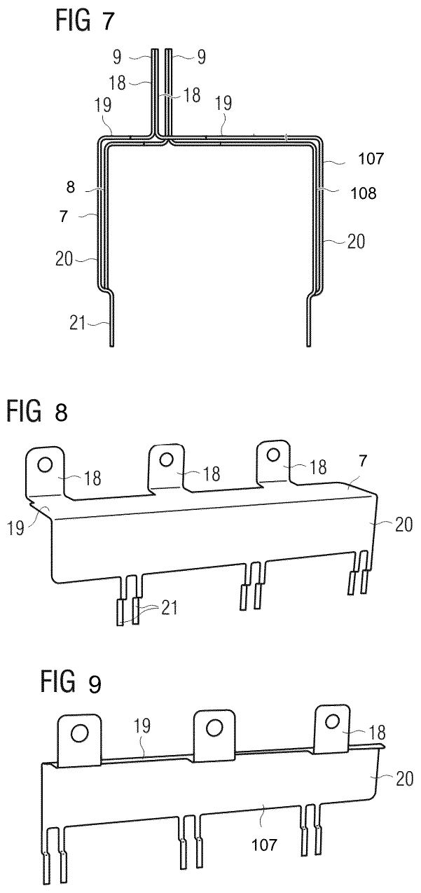

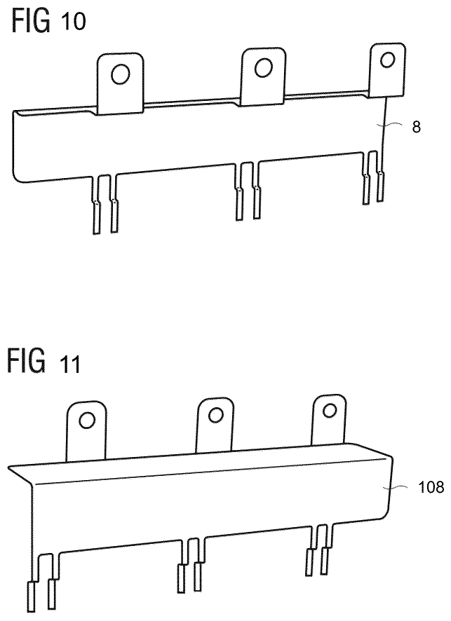

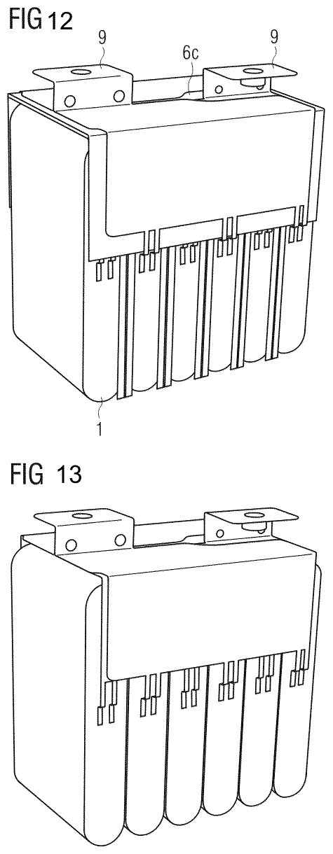

FIGS. 7 to 11 show busbars of a capacitor according to a second embodiment. FIG. 7 shows the first busbar 7, the second busbar 8, a third busbar 107 and a fourth busbar 108. The first busbar 7 is shown in FIG. 8. The third busbar 107 is shown in FIG. 9. The second busbar 8 is shown in FIG. 10. The fourth busbar 108 is shown in FIG. 12.

The winding elements 1 of the capacitor are arranged in a single stack 6. In a stacking directions S, the winding elements 1 alternate regarding their polarity.

The first busbar 7 and the second busbar 8 are both arranged on a lateral face 6c of the stack 6. The first busbar 7 and the second busbar 8 overlap each other on the first lateral face 6a of the stack.

When an alternating current is applied to the capacitor, the currents in the overlap of the first busbar 7 and the second busbar 8 have opposite directions. Thus, parasitic inductances, parasitic resistances and negative electromagnetic interactions are low.

In the stacking direction S, the top face 3 of the winding elements 1 on the first lateral face 6a are alternatingly connected to the first busbar 7 and to the second busbar 8. In the stacking direction S, the bottom face 3 of the winding elements 1 on the second lateral face 6b are alternatingly connected to the third busbar 7 and to the fourth busbar 108. The first busbar 7 and the third busbar 107 have the same polarity. The second busbar 8 and the fourth busbar 108 have the same polarity. A first group of winding elements 1 has a top face connected to the first busbar 7 and a bottom face connected to the fourth busbar 108. A second group of winding elements 1 has a top face connected to the second busbar 8 and a bottom face connected to the third busbar 107. In the stacking direction, winding elements from the first group and winding elements from the second group alternate.

This connection of the busbars to the winding elements 1 in an alternating manner results in the winding elements 1 having alternating polarities along the stacking direction S. Thereby, the magnetic flux of adjacent winding elements 1 can compensate each other. The compensation of the magnetic flux results in a low parasitic inductance, a low parasitic resistance and low negative electromagnetic interactions.

Due to the compensation of the magnetic flux, the parasitic inductances and resistances between the winding elements 1 and between the winding elements 1 and the terminals are reduced. Thereby, the impedance from the terminals 9 to each winding element 1 is more homogeneous between winding elements 1 in all the bandwidth, so the performance of the capacitor in all the bandwidth is better. In particular, the capacitor has a low and frequency stable ESR, a low ESL from each pair of terminals, a homogeneous internal current distribution and internal resonances are avoided.

Each of the busbars 7, 8, 107, 108 has a Z-shaped cross-section.

The first busbar 7 comprises a first section 18, a second section 19 and a third section 20. The second section 19 is arranged between the first section 18 and the third section 20. The second section 19 is perpendicular to each of the first section 18 and the third section 20. The first section 18 and the third section 20 are parallel to each other. This design of the first section 18, the second section 19 and the third 20 section results in the Z-shaped cross section of the first busbar 7.

The first section 18 of the first busbar 7 is part of the terminal 9 of the first busbar 7. The second section 19 of the first busbar 7 is arranged on the lateral face 6c of the stack 6. The third section 20 of the first busbar 7 is arranged on the first lateral face 6a of the stack 6. The third section 20 comprises a pair of two protrusions 21 that are electrically and mechanically connected to the top face 3 of a winding element 1. In particular, the third section 20 comprises multiple pairs of two protrusions 21 that are electrically and mechanically connected to the top face 3 of every second winding element 1 in the stacking direction S.

The third busbar 107 is designed analog to the first busbar 7. In particular, the third busbar 107 also comprises a first section 18, a second section 19 and a third section 20. The third busbar 107 also has a Z-shaped cross-section.

The first section 18 of the third busbar 107 is part of the terminal 9 of the third busbar 107. In particular, the terminal 9 is formed by the two first sections 18 of the first busbar 7 and of the third busbar 107. The second section 19 of the third busbar 107 is perpendicular to the first section 18 and is arranged on the lateral face 6c of the stack 6. The third section 20 of the third busbar 107 is perpendicular to the second section 19 and is arranged on the second lateral face 6b of the stack 6. The third section 20 comprises a pair of two protrusions 21 that are electrically and mechanically connected to the bottom face 2 of a winding element 1. In particular, the third section 20 comprises multiple pairs of two protrusions 21 that are electrically and mechanically connected to the bottom faces 2 of those winding elements 1 which have a top face 3 that is not connected to the first busbar 7.

The second busbar 8 and the fourth busbar 108 are formed analog to the first busbar 7 and the third busbar 107 and are, therefore, not described in detail.

The first busbar 7 and the second busbar 8 completely overlap each other apart from the protrusions 21 that are connected to the top face 3 of the winding elements 1. The third busbar 107 and the fourth busbar 108 completely overlap each other apart from the protrusions 21 that are connected to the bottom face 2 of the winding elements 1. Thus, the protrusions 21 are the only parts of the busbars 7, 8, 107, 108 wherein the electromagnetic flux of the busbars 7, 8, 107, 108 is not compensated by the respective other busbar. Overall, this results in a very large compensation of the electromagnetic flux in the busbars 7, 8, 107, 108.

Each of the busbars comprises multiple terminals 9. The terminals 9 are distributed symmetric with respect to the winding elements 1 along the busbars. The symmetric arrangement of the terminals 9 optimizes a current balance between the winding elements 1. A non-symmetric arrangement of the terminals 9 would result in an unbalanced current between the winding elements 1 and, thus, a reduced performance of the capacitor.

When an alternating current is applied to the terminals 9 of the busbars, the alternating current flows through each of the busbars.

The Z-shaped cross-section of each of the busbars results in a large overlapping area of the busbars. Thus, due to the large overlap, the parasitic inductances are very low, the parasitic resistances are very low and negative electromagnetic interactions can be avoided.

The busbars are electrically connected to the middle points of the top face 3 or the bottom face 2 of the winding elements 1. The busbars can be adapted to the dimensions of the winding elements 1 and can, in particular, be dimensioned such that they are connected to the middle points of the top face 3 or, respectively, the bottom face 2 of the winding elements 1 independently of the dimensions of the winding elements 1. This increases the current capability and the allowed maximum winding size.

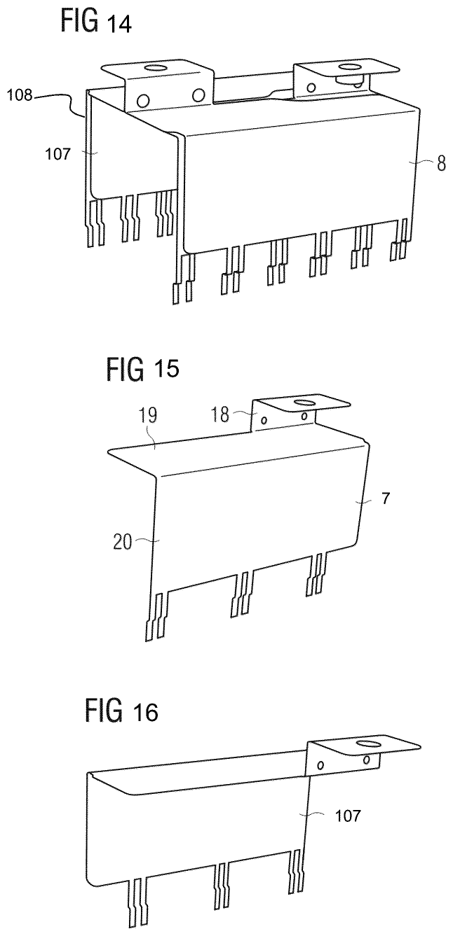

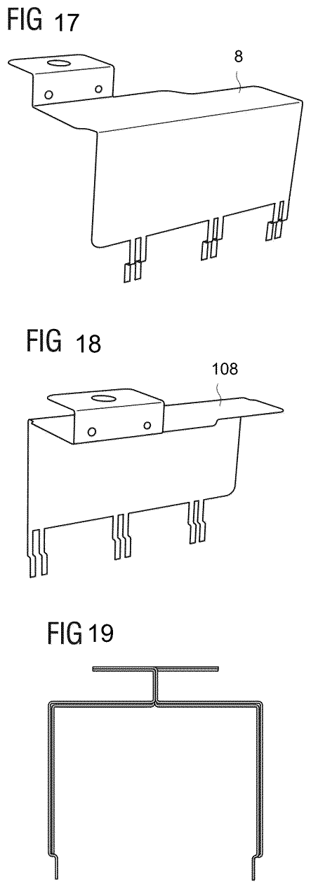

FIGS. 12 and 13 show a capacitor according to a third embodiment. FIG. 14 shows the busbars 7, 8 of the capacitor according to the third embodiment in a perspective view. FIG. 15 shows a first busbar 7. A third busbar 107 is shown in FIG. 16. A second busbar 8 is shown in FIG. 17. A fourth busbar 108 is shown in FIG. 18. FIG. 19 shows the four busbars 7, 8, 107, 108 in a cross-sectional view.

The capacitor of the third embodiment is substantially identical to the capacitor of the second embodiment and differs from the capacitor of the second embodiment only in the shape and the number of the terminals 9. According to the third embodiment, each of the first busbar 7 and the second busbar 8 has only one terminal 9. The terminal 9 is formed by a first section 18 of the first part 7a, 8a and a first section 18 of the second part 7b, 8b of the respective busbar 7, 8. The first sections 18 each comprise to sub-sections that are perpendicular to each other. Thereby, a bend terminal 9 is formed. The bend terminal 9 has a subsection that is perpendicular to the lateral face 6c of the stack 6 and a sub-section that is parallel to the lateral face 6c.

The capacitor of the third embodiment has the same advantages as the capacitor of the second embodiment resulting from a large overlap of the busbars 7, 8 and from the arrangement of the winding elements 1 with alternating polarity.

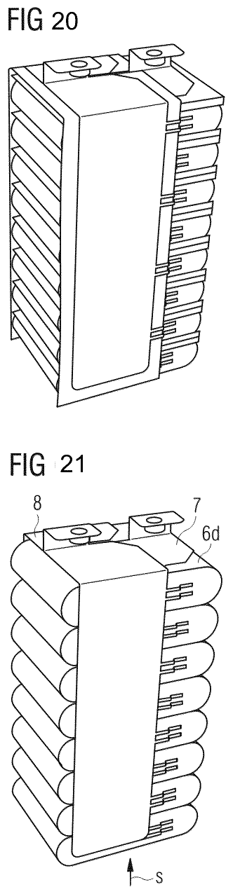

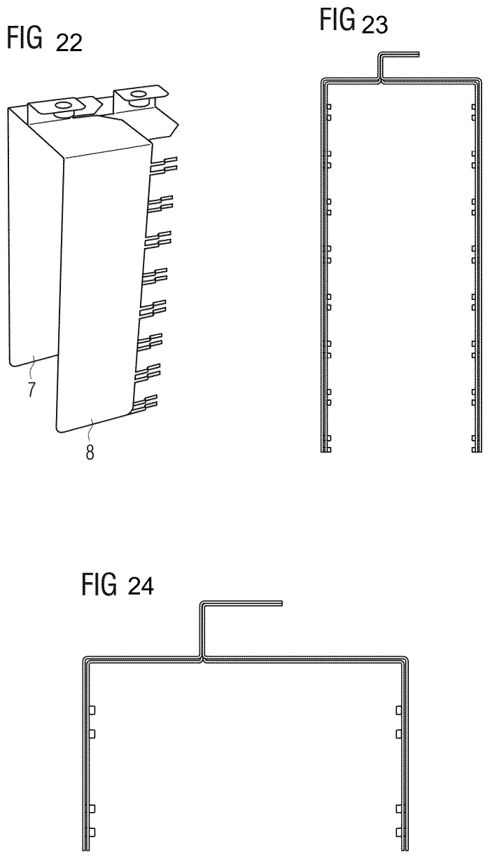

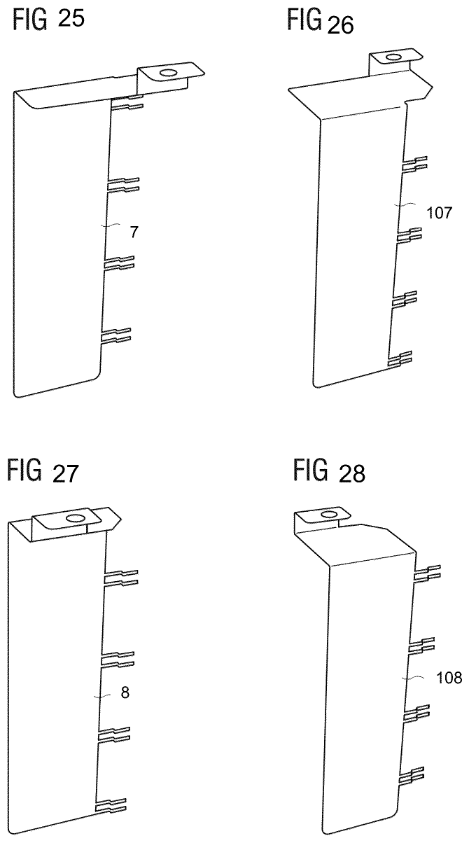

FIGS. 20 and 21 show a capacitor according to a fourth embodiment. FIG. 22 shows the busbars 7, 8, 107, 108 of the capacitor according to the fourth embodiment in a perspective view. FIG. 23 shows the busbars 7, 8, 107, 108 in a cross-sectional view. FIG. 24 shows an enlarged view of a part of FIG. 23. FIG. 25 shows a first busbar 7. A third busbar 107 is shown in FIG. 26. A second busbar 8 is shown in FIG. 27. A fourth busbar 108 is shown in FIG. 28.

The capacitor according to the fourth embodiment differs from the capacitor of the third embodiment in that the terminals 9 are arranged on a different lateral face 6d, i.e. on a lateral face 6d having a surface normal that is parallel to the stacking direction S. In contrast to this, the terminals 9 of the capacitor of the third embodiment are arranged on the lateral face 6c wherein the surface normal of the lateral face 6c is perpendicular to the stacking direction S. The other features of the capacitor of the fourth embodiment are identical to the capacitor of the third embodiment. The capacitor of the fourth embodiment has the same advantages as the capacitor of the second embodiment and the capacitor of the third embodiment resulting from a large overlap of the busbars 7, 8 and from the arrangement of the winding elements 1 with alternating polarity.

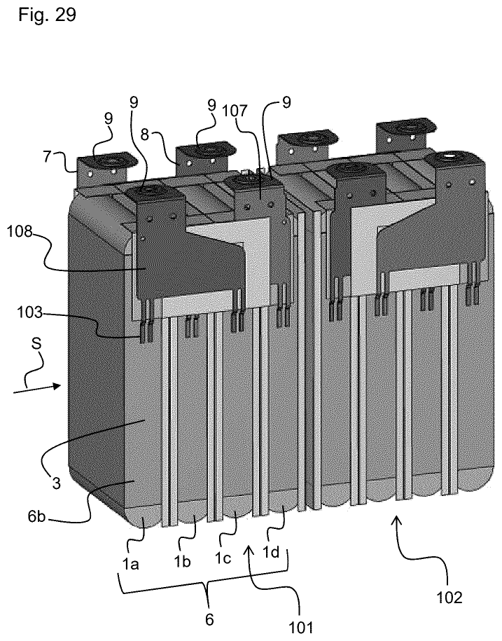

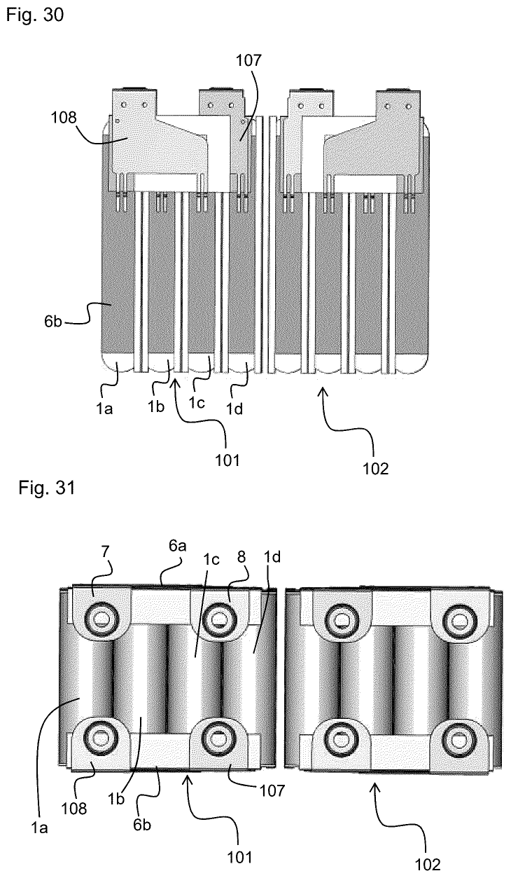

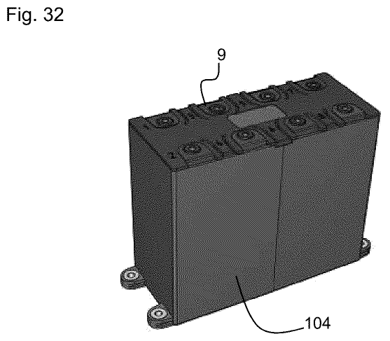

FIG. 29 shows a perspective view of a fifth embodiment of the capacitor. FIG. 30 shows a side view of the capacitor according to the fifth embodiment. FIG. 31 shows a top view of the capacitor according to the fifth embodiment. FIG. 32 shows the capacitor of the fifth embodiment wherein the capacitor units are enclosed in an encapsulation. In FIGS. 29, 30 and 31, the encapsulation is not shown for a better illustration of the other features.

The capacitor according to the fifth embodiment comprises two capacitor units 101, 102. In the following, the first capacitor unit 101 is described. The second capacitor unit 102 is constructed identically. Each capacitor unit 101, 102 comprises four winding elements arranged in a single stack 6, i.e. a first winding element 1a, a second winding element 1b, a third winding element 1c and a fourth winding element 1d. The winding elements 1a-1d in the stack 6 are arranged such that the top faces 3 of the winding elements form a first lateral face 6a of the stack 6 and the bottom faces 2 of the winding elements 1a-1d form a second lateral face 6b of the stack 6. The second lateral face 6b is opposite of the first lateral face 6a. A stacking direction S of the stack 6 is perpendicular to a surface normal of the first lateral face 6a and the stacking direction S of the stack 6 is perpendicular to a surface normal of the second lateral face 6b.

Each capacitor unit comprises a first busbar 7, a second busbar 8, a third busbar 107 and a fourth busbar 108. The first busbar 7 and the second busbar 8 are arranged on the first lateral face 6a of the stack. The first busbar 7 and the second busbar 8 overlap each other. The third busbar 107 and the fourth busbar 108 are arranged on the second lateral face 6b of the stack. The third busbar 107 and the fourth busbar 108 overlap each other. In the area of the overlap of the busbars 7, 8, 107, 108, a thin isolator is arranged between the busbars which prevents a short circuit between the busbars. Due to the overlap of the first busbar 7 and the second busbar 8 and, respectively, the overlap of the third busbar 107 and the fourth busbar 108, a capacitor unit is provided which has a characteristic that is well suited for power applications. When a current flows through the first busbar 7, a magnetic field is generated by the current. Further, when a current flows through the second busbar 8, another magnetic field is generated by this current. Due to the overlap of the first busbar 7 and the second busbar 8, the magnetic fields have opposite orientations and, therefore, weaken or even cancel each other. Analogously, due to the overlap of the third busbar 107 and the fourth busbar 108, the magnetic fields generated by currents flowing through the third busbar and the fourth busbar have opposite orientations and, therefore, weaken or even cancel each other. Thus, overall, only a very weak magnetic field is generated, when a current is applied to the busbars. This results in a small inductance of the connection of the busbars 7, 8, 107, 108 and between the winding elements 1a-1d. Thus, the inductance of the capacitor unit is very small.

A capacitor with overlapping busbars has a low equivalent series resistance (ESR), a frequency-stable ESR, a low equivalent series inductance (ESL), and a homogeneous internal current distribution. Internal resonances may be avoided.

The first winding element 1a is the outermost winding element of the stack 6. The second winding element 1b is adjacent to the first winding element 1a in the stacking direction S. The third winding element 1c is adjacent to the second winding element 1b in the stacking direction S. The fourth winding element id is adjacent to the third winding element 1c in the stacking direction S. The fourth winding element id is the last winding element of the stack 6 of the first capacitor unit 101.

The first busbar 7 is connected to the top face 2 of the first winding element 1a and the fourth busbar 108 is connected to the bottom face 3 of the first winding element 1a. The second busbar 8 is connected to the top face 2 of the second winding element 1b and the third busbar 107 is connected to the bottom face 3 of the second winding element 1b. The first busbar 7 is connected to the top face 2 of the third winding element 1c and the fourth busbar 108 is connected to the bottom face 3 of the third winding element 1c. The second busbar 8 is connected to the top face 2 of the fourth winding element id and the third busbar 107 is connected to the bottom face 3 of the fourth winding element 1d.

Each busbar comprises a terminal 9 which is configured to be connected to an external connection. Thus, each of the capacitor units 101, 102 comprises four terminals 9. Due to the rather large number of four terminals 9 per capacitor unit, the self-inductance of the capacitor unit is very small and, thereby, the self-inductance of the entire capacitor is also very small.

Via the external connection, a first potential can be applied to the first busbar 7 and to the third busbar 107. Via the external connection, an opposite potential can be applied to the second busbar 8 and to the fourth busbar 108. In this case, a current flows through adjacent winding elements in an opposite direction.

Thereby, the polarities of the winding elements 1a-1d alternate along the stacking direction S. In other words, in the stacking direction, each winding element has an opposite polarity compared to the adjacent winding element.

As a result, the magnetic flux is compensated in all connections, including the connection between winding elements 1a-1d. This results in only very small parasitic inductances and resistances between winding elements 1a-1d and between winding elements 1a-1d and terminals 9. By reducing the parasitic inductances and resistances, the impedance from the terminals to each winding is more homogeneous between the winding elements for each frequency in the bandwidth in which the capacitor is operated. Thus, the performance of the capacitor in the complete bandwidth is better due to a low and frequency stable ESR, a low ESL from each pair of terminals, a homogeneous internal current distribution and the avoidance of internal resonances.

Each busbar 7, 8, 107, 108 comprises at least two tabs 103. Each busbar is connected to a top face 2 or, respectively, to a bottom face 3 of the respective winding element 1a-1d by at at least one tabs 103. Each tab 103 defines a connection point at which the winding element 1a-1d and the busbar 7, 8, 107, 108 are connected. Thus, the busbars 7, 8, 107, 108 are connected to the respective top faces 2 or bottom faces 3. For example, the first busbar 7 is connected to the top face 2 of the first winding element 1a by at least one tabs 103 at at least one connection point and, further, the first busbar 7 is connected to the top face 2 of the third winding element 1C by at least one tab 103 at at least one connection point.

Each busbar 7, 8, 107, 108 comprises a substantially flat metal plate with tabs 103 being arranged at a lower end and the terminal 9 being arranged at the upper end. The terminal 9 is bend by 90° relative to the flat metal plate.

In the embodiment shown in FIGS. 29 to 32, the capacitor comprises two identical capacitor units 101, 102. In alternate embodiments, the number of capacitor units can be different. For example, the capacitor may comprise only a single capacitor unit 101. Alternatively, the capacitor may comprise three or more capacitor units.

The capacitor further comprises an encapsulation 104. The encapsulation encloses all capacitor units 101, 102 of the capacitor such that only the terminals 9 protrude from the encapsulation 104.

For all the embodiments described above, the quantity of the winding elements 1 per capacitor can be varied. The shape and the dimensions of the winding elements 1 can also be varied in all of the above described embodiments. The terminal 9 layout can also be varied in each of the embodiments.

1. -20. (canceled)

21. A capacitor comprising:
at least one capacitor unit comprising:
at least two winding elements;
a first busbar;
a second busbar;
a third busbar; and
a fourth busbar,
wherein all winding elements are arranged in a single stack,
wherein the first busbar and the second busbar are arranged such that they overlap each other,
wherein the first busbar and the second busbar are arranged at a first lateral face of the stack, which has a surface normal perpendicular to a stacking direction of the stack,
wherein, in the stacking direction, alternatingly either the first busbar or the second busbar is connected to a top face of the winding elements,
wherein the third busbar and the fourth busbar are arranged such that they overlap each other,
wherein the third busbar and the fourth busbar are arranged on a second lateral face of the stack opposite to the first lateral face, and
wherein, in the stacking direction, alternatingly either the third busbar or the fourth busbar is connected to a bottom face of the winding elements such that the third busbar is connected to the bottom faces of the winding elements, which have a top face that is connected to the second busbar and that the fourth busbar is connected to the bottom faces of the winding elements, which have a top face that is connected to the first busbar.

22. The capacitor according to claim 21,
wherein the first busbar and the second busbar are arranged such that at least 20% of an area of the first busbar is overlapped by the second busbar, and
wherein the third busbar and the fourth busbar are arranged such that at least 20% of an area of the third busbar is overlapped by the fourth busbar.

23. The capacitor according to claim 21,
wherein the first busbar and the second busbar are arranged such that a current flowable through the first busbar is able to generate a first magnetic field and a current flowable through the second busbar is able to generate a second magnetic field, the first magnetic field and the second magnetic field able to compensate each other, and
wherein the third busbar and the fourth busbar are arranged such that a current flowable through the third busbar is able to generate a third magnetic field and a current flowable through the fourth busbar is able to generate a fourth magnetic field, the third magnetic field and the fourth magnetic field able to compensate each other.

24. The capacitor according to claim 21,
wherein each winding element has an A pole and a B pole,
wherein the A poles of each winding element are connected either to the first busbar or to the third busbar, and
wherein the B poles of each winding element are connected either to the second busbar or to the fourth busbar.

25. The capacitor according to claim 21, wherein each busbar is connected to the winding elements directly.

26. The capacitor according to claim 21, wherein each busbar is connected to the top face or to the bottom face of a respective winding element.

27. The capacitor according to claim 21, wherein each busbar comprises a terminal configured for connecting to an external connection.

28. The capacitor according to claim 21, wherein each busbar comprises a flat metal plate with tabs arranged at a lower end, and wherein a terminal is arranged at an upper end.

29. The capacitor according to claim 21, wherein the capacitor does not comprise an internal connection.

30. The capacitor according to claim 21, wherein, in the stacking direction, each winding element has an opposite polarity compared to an adjacent winding element.

31. The capacitor according to claim 21, wherein, the winding elements are arranged in the stack such that the top faces of the winding elements are arranged at the first lateral face of the stack and the bottom faces of the winding elements are arranged at the second lateral face of the stack.

32. The capacitor according to claim 21, wherein the winding elements have a non-circular diameter.

33. The capacitor according to claim 21, further comprising an encapsulation enclosing the capacitor unit.

34. A capacitor comprising:
two or more capacitor units, each capacitor unit comprising:
at least two winding elements;
a first busbar;
a second busbar;
a third busbar; and
a fourth busbar,
wherein all winding elements of each capacitor unit are arranged in a single stack,
wherein the first busbar and the second busbar are arranged such that they overlap each other,
wherein the first busbar and the second busbar are arranged at a first lateral face of the stack, which has a surface normal perpendicular to a stacking direction of the stack,
wherein, in the stacking direction, alternatingly either the first busbar or the second busbar is connected to a top face of the winding elements,
wherein the third busbar and the fourth busbar are arranged such that they overlap each other,
wherein the third busbar and the fourth busbar are arranged on a second lateral face of the stack opposite to the first lateral face, and
wherein, in the stacking direction, alternatingly either the third busbar or the fourth busbar is connected to a bottom face of the winding elements such that the third busbar is connected to the bottom faces of the winding elements, which have a top face that is connected to the second busbar and that the fourth busbar is connected to the bottom faces of the winding elements, which have a top face that is connected to the first busbar.

35. The capacitor according to claim 34, wherein the two or more capacitor units are arranged such that the stacks of winding elements of each of the two or more capacitor units are arranged in one or more rows, and wherein the stacking direction of the stacks are parallel to each other.

36. The capacitor according to claim 34, further comprising an encapsulation enclosing the capacitor units.

37. The capacitor according to claim 34, wherein, in each capacitor unit, each busbar of each capacitor unit is connected to the top face or to the bottom face of the respective winding element.

38. The capacitor according to claim 34, wherein each busbar comprises a terminal, which is configured for connection to an external connection.

39. The capacitor according to claim 34, wherein each of the busbars comprises a flat metal plate with tabs arranged at a lower end, and wherein a terminal is arranged at an upper end.

40. The capacitor according to claim 34, wherein the capacitor does not comprise an internal connection.

41. The capacitor according to claim 21,
wherein the stack comprises a third lateral face and a fourth lateral face which each connect the first lateral face to the second lateral face and which have a surface normal which is perpendicular to the stacking direction, and
wherein the third lateral face and the fourth lateral face are free of each of the first busbar, the second busbar, the third busbar and the fourth busbar.

42. The capacitor according to claim 34,
wherein the stack comprises a third lateral face and a fourth lateral face which each connect the first lateral face to the second lateral face and which have a surface normal which is perpendicular to the stacking direction, and
wherein the third lateral face and the fourth lateral face are free of each of the first busbar, the second busbar, the third busbar and the fourth busbar.

43. Power electronics comprising:
the capacitor according to claim 21.

44. Power electronics comprising:
the capacitor according to claim 34.
